(19) United States
(12) Patent Application Publication
(10) Pub. No.: US 2020/0189674 A1
(43) Pub. Date: Jun. 18, 2020

(54) Utility Trailer

(71) Applicant: Richard Dove, Durham, NC (US)

(72) Inventor: Richard Dove, Durham, NC (US)

(21) Appl. No.: 16/220,611

(22) Filed: Dec. 14, 2018

(51) Int. Cl. B62D 63/06; B60P 1/43

(52) U.S. Cl. CPC B62D 63/062; B60P 3/07; B60P 1/435

(57) ABSTRACT

A utility trailer for selectively towing a motorcycle or a load includes a frame that is rectangularly shaped. A plate is coupled to a top of the frame. A plurality of axles is rotationally coupled to a bottom of the frame. Each of a plurality of trailer wheels is coupled to a respective opposing end of a respective axle. A tongue is coupled to and extends from a front of the frame. A coupler is coupled to the tongue distal from the frame. The coupler is configured to couple the tongue to a hitch. A track is removably couplable to an upper face of the plate. The track is configured to position and stabilize a motorcycle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### Description of Related Art including information disclosed under 37 CFR 1.97 and 1.98.

The disclosure and prior art relates to trailers and more particularly pertains to a new trailer for selectively towing a motorcycle or a load.

### BRIEF SUMMARY OF THE INVENTION

An embodiment of the disclosure meets the needs presented above by generally comprising a frame that is rectangularly shaped. A plate is coupled to a top of the frame. A plurality of axles is rotationally coupled to a bottom of the frame. Each of a plurality of trailer wheels is coupled to a respective opposing end of a respective axle. A tongue is coupled to and extends from a front of the frame. A coupler is coupled to the tongue distal from the frame. The coupler is configured to couple the tongue to a hitch. A track is removably couplable to an upper face of the plate. The track is configured to position and stabilize a motorcycle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a utility trailer according to an embodiment of the disclosure.

FIG. 2 is an isometric perspective view of an embodiment of the disclosure.

FIG. 3 is a side view of an embodiment of the disclosure.

FIG. 4 is a top view of an embodiment of the disclosure.

FIG. 5 is an in-use view of an embodiment of the disclosure.

### DETAILED DESCRIPTION OF THE INVENTION

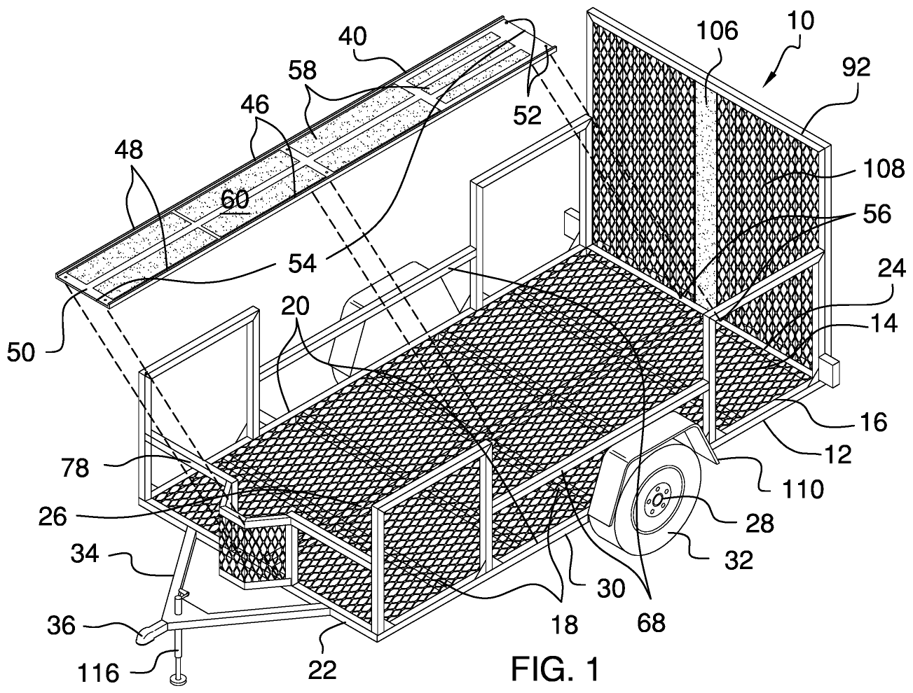

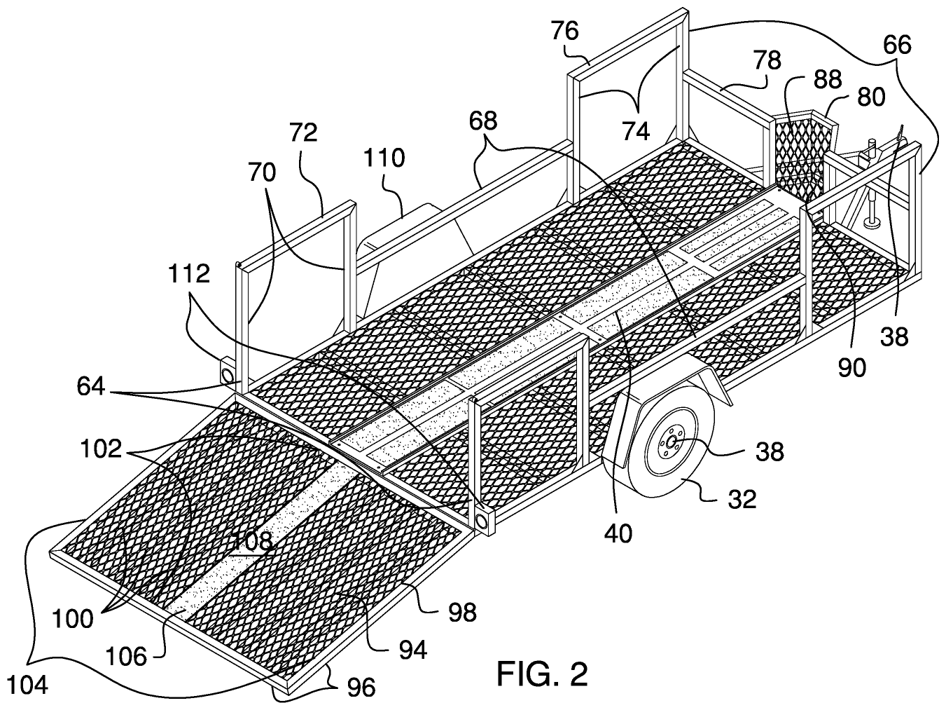

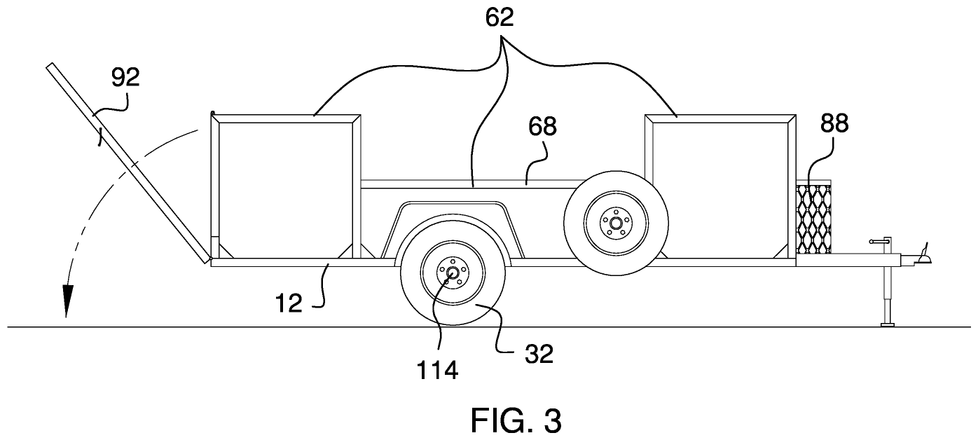

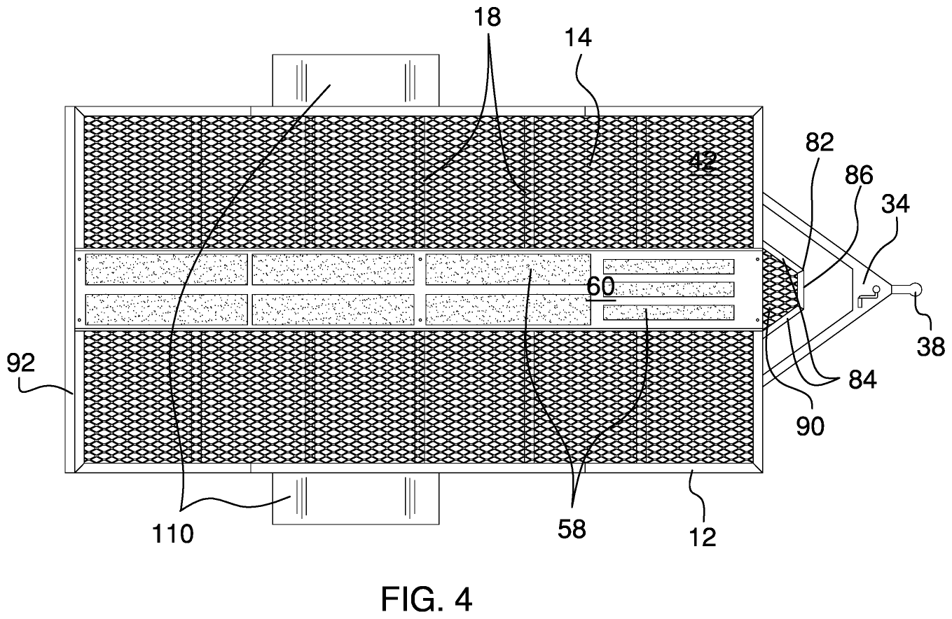

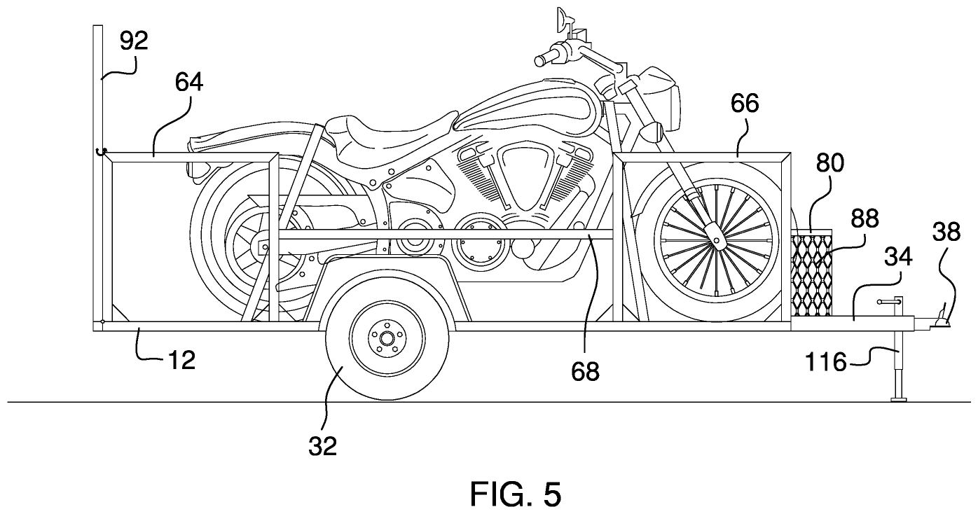

With reference now to the drawings, and in particular to FIGS. 1 through 5 thereof, a new trailer embodying the principles and concepts of an embodiment of the disclosure and generally designated by the reference numeral 10 will be described.

As best illustrated in FIGS. 1 through 5, the utility trailer 10 generally comprises a frame 12. The frame 12 is rectangularly shaped. A plate 14 is coupled to a top 16 of the frame 12. The plate 14 comprises diamond steel mesh. Each of a plurality of crossbeams 18 is coupled to and extends between opposing sides 20 of the frame 12. The plurality of crossbeams 18 comprises five crossbeams 18 that are substantially evenly space between a front 22 and a back 24 of the frame 12.

Each of a plurality of runner beams 26 is coupled to and extends between the front 22 and the back 24 of the frame 12. The runner beam 26 is coupled to each of the crossbeams 18. The plurality of runner beams 26 comprises a single runner beam 26 that is positioned equally distant from the opposing sides 20 of the frame 12.

A plurality of axles 28 is rotationally coupled to a bottom 30 of the frame 12. The plurality of axles 28 comprises one axle 28 that is positioned substantially equally distant from the front 22 and the back 24 of the frame 12. Each of a plurality of trailer wheels 32 is coupled to a respective opposing end 114 of a respective axle 28. The present invention also anticipates a spare trailer wheel 32 coupled to the utility trailer 10.

A tongue 34 is coupled to and extends from the front 22 of the frame 12. The tongue 34 is A-frame 12 type. A coupler 36 is coupled to the tongue 34 distal from the frame 12. The coupler 36 is configured to couple the tongue 34 to a hitch. The coupler 36 comprises a receiver 38 for a tow ball. A trailer jack 116 is coupled to the tongue 34 proximate to the coupler 36 and is configured to selectively elevate the receiver 38 to allow insertion of the tow ball into the receiver 38.

A track 40 is removably couplable to an upper face 42 of the plate 14 so that the track 40 is configured to position and stabilize a motorcycle. The track 40 extends between the front 22 and the back 24 of the frame 12 and is positioned equally distant from the opposing sides 20 of the frame 12. The utility trailer 10 is thus capable of transporting the motorcycle, with the track 40 attached to the plate 14, as well as other loads when the track 40 is not used.

The track 40 comprises a first panel 44 and a pair of second panels 46. Each second panel 46 is coupled to and extends perpendicularly from a respective opposing edge 48 of the first panel 44 so that the first panel 44 and the pair of second panels 46 define an open-ended channel 50.

A plurality of first holes 52 is positioned in the first panel 44 proximate to opposing terminal edges 54 of the first panel 44. Each of the plurality of first holes 52 is selectively alignable with a respective one of a plurality of second holes 56 that is positioned in the frame 12, positioning the first hole 52 and the respective second hole 56 for threadedly inserting an article of mounting hardware, such as a metal screw, for coupling the track 40 to the frame 12. The plurality of first holes 52 comprises four first holes 52 that are positioned two-apiece proximate to each opposing terminal edge 54 of the first panel 44 and two first holes 52 positioned substantially equally distant from the opposing terminal edges 54.

A plurality of channel strips 58 is coupled to an upper surface 60 of the first panel 44. The channel strips 58 are textured so that the channel strips 58 are configured to increase traction of the wheels of the motorcycle on the first panel 44.

Each of a pair of siderails 62 is coupled to and extends from a respective opposing side 20 of the frame 12. The siderails 62 are configured to retain a load on the plate 14. Each siderail 62 comprises a pair of rearward members 64, a pair of forward members 66 and a pair of crossbars 68. Each rearward member 64 is positioned between the plurality of axles 28 and the back 24 of the frame 12. Each rearward member 64 comprises a pair of first bars 70 and a second bar 72. The first bars 70 are coupled to and extend perpendicularly from the frame 12. The second bar 72 is coupled to and extends between the first bars 70 distal from the frame 12.

Each forward member 66 is positioned between the plurality of axles 28 and the front 22 of the frame 12. Each forward member 66 comprises a pair of third bars 74 and a fourth bar 76. The third bars 74 are coupled to and extend perpendicularly from the frame 12. The fourth bar 76 is coupled to and extends between the third bars 74 distal from the frame 12. Each crossbar 68 is coupled to a respective rearward member 64 and an associated forward member 66.

A forward rail 78 is coupled to and extends between the pair of siderails 62 proximate to the front 22 of the frame 12. The forward rail 78 is configured to retain the load on the plate 14. An offset 80, which is half-hexagonally shaped, is positioned in the forward rail 78 and extends from the front 22 of the frame 12. The offset 80 is configured to choke a wheel of the motorcycle.

An extension 82 is coupled to and extends from the front 22 of the frame 12 so that the extension 82 is positioned parallel planarly to the offset 80. The extension 82 is shaped and sized complementarily to the offset 80. The extension 82 comprises a pair of lower bars 84 and a medial bar 86. The lower bars 84 are coupled to and extend transversely from the front 22 of the frame 12. The medial bar 86 is coupled to and extends between the lower bars 84 distal from the frame 12 so that the pair of lower bars 84 and the medial bar 86 are half-hexagonally shaped.

A first chock panel 88 is coupled to and extends between the offset 80 and the extension 82. A second chock panel 90 is coupled to and extends between the extension 82 and the front 22 of the frame 12. The first chock panel 88 and the second chock panel 90 comprise diamond steel mesh.

A ramp 92 is pivotally coupled to the back 24 of the frame 12. The ramp 92 is positioned to be selectively pivoted relative to the frame 12 so that the ramp 92 is positionable in a lowered configuration, wherein the ramp 92 extends between the frame 12 and a surface. The ramp 92 in the lowered configuration is configured to aid the raising of the motorcycle to the track 40. The ramp 92 also is positioned to be selectively pivoted relative to the frame 12 so that the ramp 92 is positioned in a raised configuration wherein the ramp 92 extends perpendicularly from the frame 12 to stow the ramp 92. The ramp 92 in the raised configuration is configured to retain the load on the plate 14. The ramp 92 may be secured to the siderails 62 using methods well known to those skilled in the art of trailer ramps.

The ramp 92 comprises a gate panel 94 that is rectangularly shaped. The gate panel 94 comprises diamond steel mesh. A border beam 96 is coupled to a perimeter 98 of the gate panel 94. Each of a plurality of medial beams 100 has opposing endpoints 102 that are coupled to the border beam 96. The plurality of medial beams 100 comprises seven medial beams 100 that are substantially evenly spaced between opposing outer edges 104 of the gate panel 94.

A panel strip 106 is coupled to an upward face 108 of the ramp 92 so that the panel strip 106 is aligned with the track 40. The panel strip 106 is textured so that the panel strip 106 is configured to increase traction of the wheels of the motorcycle on the ramp 92. As the panel strip 106 is aligned with the track 40, is also serves to guide the user in driving the motorcycle up the ramp 92 and into the open-ended channel 50.

A plurality of fenders 110 is coupled to and extends from the opposing sides 20 of the frame 12 so that each fender 110 is positioned to shield at least one trailer wheel 32. The plurality of fenders 110 comprises two fenders 110 that are coupled singly to the opposing sides 20 of the frame 12.

The utility trailer 10 also comprises a pair of indicators 112. The pair of indicators 112 is selectively operationally couplable to a control module of a vehicle that is coupled to the tongue 34. Each indicator 112 is coupled to a respective siderail 62 adjacent to the back 24 of the frame 12. The indicators 112 are configured to selectively signal braking and turning of the vehicle.

In use, the utility trailer 10 is preconfigured for transporting the load selected by the user. When the user wishes to transport the motorcycle, the track 40 is attached to the plate 14 and the motorcycle is loaded using the ramp 92.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A utility trailer comprising:
a frame, the frame being rectangularly shaped;
a plate coupled to a top of the frame;
a plurality of axles rotationally coupled to a bottom of the frame;
a plurality of trailer wheels, each trailer wheel being coupled to a respective opposing end of a respective axle;
a tongue coupled to and extending from a front of the frame;
a coupler coupled to the tongue distal from the frame wherein the coupler is configured for coupling the tongue to a hitch; and
a track removably couplable to an upper face of the plate wherein the track is configured for positioning and stabilizing a motorcycle.

2. The trailer of claim 1, further comprising:
the plate comprising diamond steel mesh;
a plurality of crossbeams, each crossbeam being coupled to and extending between opposing sides of the frame; and
a plurality of runner beams, each runner beam being coupled to and extending between the front and a back of the frame, the runner beam being coupled to each of the crossbeams.

3. The trailer of claim 2, further comprising:
the plurality of crossbeams comprising five crossbeams substantially evenly space between the front and the back of the frame; and
the plurality of runner beams comprising a single runner beam positioned equally distant from the opposing sides of the frame.

4. The trailer of claim 1, further comprising:
the plurality of axles comprising one axle positioned substantially equally distant from the front and a back of the frame;
the tongue being A-frame type;
the coupler comprising a receiver for a tow ball;
a trailer jack coupled to the tongue proximate to the coupler wherein the trailer jack is configured for selectively elevating the receiver for inserting the tow ball into the receiver; and
the track extending between the front and the back of the frame, the track being positioned equally distant from the opposing sides of the frame.

5. The trailer of claim 1, further including the track comprising:
a first panel;
a pair of second panels, each second panel being coupled to and extending perpendicularly from a respective opposing edge of the first panel such that the first panel and the pair of second panels define an open-ended channel; and
a plurality of first holes positioned in the first panel proximate to opposing terminal edges of the first panel, each first hole being selectively alignable with a respective one of a plurality of second holes positioned in the frame, positioning the first hole and the respective second hole for threadedly inserting an article of mounting hardware for coupling the track to the frame, the plurality of first holes comprises four first holes positioned two-apiece proximate to each opposing terminal edge of the first panel and two first holes positioned substantially equally distant from the opposing terminal edges.

6. The trailer of claim 5, further including a plurality of channel strips coupled to an upper surface of the first panel, the channel strips being textured wherein the channel strips are configured for increasing traction of the wheels of the motorcycle on the first panel.

7. A plurality of first holes is positioned in opposing terminal edges of the first panel. Each of the plurality of first holes is selectively alignable with a respective one of a plurality of second holes that is positioned in the frame, positioning the first hole and the respective second hole for threadedly inserting an article of mounting hardware, such as a bolt, for coupling the track to the frame

8. The trailer of claim 1, further comprising:
a pair of siderails, each siderail being coupled to and extending from a respective opposing side of the frame; and
a forward rail coupled to and extending between the pair of siderails proximate to the front of the frame wherein the pair of siderails and the forward rail are configured for retaining a load on the plate.

9. The trailer of claim 8, further comprising:
each siderail comprising:
a pair of rearward members, each rearward member being positioned between the plurality of axles and a back of the frame, each rearward member comprising a pair of first bars and a second bar, the first bars being coupled to and extending perpendicularly from the frame, the second bar being coupled to and extending between the first bars distal from the frame,
a pair of forward members, each forward member being positioned between the plurality of axles and the front of the frame, each forward member comprising a pair of third bars and a fourth bar, the third bars being coupled to and extending perpendicularly from the frame, the fourth bar being coupled to and extending between the third bars distal from the frame, and
a pair of crossbars, each crossbar being coupled to a respective rearward member and an associated forward member; and
an offset positioned in the forward rail and extending from the front of the frame wherein the offset is configured for choking a wheel of the motorcycle.

10. The trailer of claim 9, further comprising:
an extension coupled to and extending from the front of the frame such that the extension is positioned parallel planarly to the offset, the extension being shaped and sized complementarily to the offset;
a first chock panel coupled to and extending between the offset and the extension; and
a second chock panel coupled to and extending between the extension and the front of the frame.

11. The trailer of claim 10, further comprising:
the offset being half-hexagonally shaped;
the extension comprising:
a pair of lower bars coupled to and extending transversely from the front of the frame, and
a medial bar coupled to and extending between the lower bars distal from the frame such that the pair of lower bars and the medial bar are half-hexagonally shaped; and
the first chock panel and the second chock panel comprising diamond steel mesh.

12. The trailer of claim 1, further including a ramp pivotally coupled to a back of the frame wherein the ramp is positioned for selectively pivoting relative to the frame such that the ramp is positionable in a lowered configuration wherein the ramp extends between the frame and a surface wherein the ramp is configured for aiding the raising of the motorcycle to the track and such that the ramp is positionable in a raised configuration wherein the ramp extends perpendicularly from the frame for stowing the ramp and wherein the ramp is configured for retaining a load on the plate.

13. The trailer of claim 12, further including the ramp comprising:
a gate panel, the gate panel being rectangularly shaped, the gate panel comprising diamond steel mesh;
a border beam coupled to a perimeter of the gate panel; and
a plurality of medial beams, each medial beam having opposing endpoints coupled to the border beam, the plurality of medial beams comprising seven medial beams substantially evenly spaced between opposing outer edges of the gate panel.

14. The trailer of claim 1, further including a panel strip coupled to an upward face of the ramp such that the panel strip is aligned with the track, the panel strip being textured wherein the panel strip is configured for increasing traction of the wheels of the motorcycle on the ramp.

15. The trailer of claim 1, further a plurality of fenders coupled to and extending from opposing sides of the frame such that each fender is positioned for shielding at least one trailer wheel, the plurality of fenders comprising two fenders coupled singly to the opposing sides of the frame.

16. The trailer of claim 8, further including a pair of indicators, the pair of indicators being selectively operationally couplable to a control module of a vehicle coupled to the tongue, each indicator being coupled to a respective siderail adjacent to the a back of the frame wherein the indicators are configured for selectively signaling braking and turning of the vehicle.

17. A utility trailer comprising:
a frame, the frame being rectangularly shaped;
a plate coupled to a top of the frame, the plate comprising diamond steel mesh;
a plurality of crossbeams, each crossbeam being coupled to and extending between opposing sides of the frame, the plurality of crossbeams comprising five crossbeams substantially evenly space between a front and a back of the frame;
a plurality of runner beams, each runner beam being coupled to and extending between the front and the back of the frame, the runner beam being coupled to each of the crossbeams, the plurality of runner beams comprising a single runner beam positioned equally distant from the opposing sides of the frame;
a plurality of axles rotationally coupled to a bottom of the frame, the plurality of axles comprising one axle positioned substantially equally distant from the front and the back of the frame;
a plurality of trailer wheels, each trailer wheel being coupled to a respective opposing end of a respective axle;
a tongue coupled to and extending from the front of the frame, the tongue being A-frame type;
a coupler coupled to the tongue distal from the frame wherein the coupler is configured for coupling the tongue to a hitch, the coupler comprising a receiver for a tow ball;
a trailer jack coupled to the tongue proximate to the coupler wherein the trailer jack is configured for selectively elevating the receiver for inserting the tow ball into the receiver;
a track removably couplable to an upper face of the plate wherein the track is configured for positioning and stabilizing a motorcycle, the track extending between the front and the back of the frame, the track being positioned equally distant from the opposing sides of the frame, the track comprising:
a first panel,
a pair of second panels, each second panel being coupled to and extending perpendicularly from a respective opposing edge of the first panel such that the first panel and the pair of second panels define an open-ended channel, and
a plurality of first holes positioned in the first panel proximate to opposing terminal edges of the first panel, each first hole being selectively alignable with a respective one of a plurality of second holes positioned in the frame, positioning the first hole and the respective second hole for threadedly inserting an article of mounting hardware for coupling the track to the frame, the plurality of first holes comprises four first holes positioned two-apiece proximate to each opposing terminal edge of the first panel and two first holes positioned substantially equally distant from the opposing terminal edges;
a plurality of channel strips coupled to an upper surface of the first panel, the channel strips being textured wherein the channel strips are configured for increasing traction of the wheels of the motorcycle on the first panel;
a pair of siderails, each siderail being coupled to and extending from a respective opposing side of the frame wherein the siderails are configured for retaining a load on the plate, each siderail comprising:
a pair of rearward members, each rearward member being positioned between the plurality of axles and the back of the frame, each rearward member comprising a pair of first bars and a second bar, the first bars being coupled to and extending perpendicularly from the frame, the second bar being coupled to and extending between the first bars distal from the frame,
a pair of forward members, each forward member being positioned between the plurality of axles and the front of the frame, each forward member comprising a pair of third bars and a fourth bar, the third bars being coupled to and extending perpendicularly from the frame, the fourth bar being coupled to and extending between the third bars distal from the frame, and
a pair of crossbars, each crossbar being coupled to a respective rearward member and an associated forward member;
a forward rail coupled to and extending between the pair of siderails proximate to the front of the frame wherein the forward rail is configured for retaining the load on the plate;
an offset positioned in the forward rail and extending from the front of the frame wherein the offset is configured for choking a wheel of the motorcycle, the offset being half-hexagonally shaped;
an extension coupled to and extending from the front of the frame such that the extension is positioned parallel planarly to the offset, the extension being shaped and sized complementarily to the offset, the extension comprising:
a pair of lower bars coupled to and extending transversely from the front of the frame, and
a medial bar coupled to and extending between the lower bars distal from the frame such that the pair of lower bars and the medial bar are half-hexagonally shaped;
a first chock panel coupled to and extending between the offset and the extension, the first chock panel comprising diamond steel mesh;
a second chock panel coupled to and extending between the extension and the front of the frame, the second chock panel comprising diamond steel mesh;
a ramp pivotally coupled to the back of the frame wherein the ramp is positioned for selectively pivoting relative to the frame such that the ramp is positionable in a lowered configuration wherein the ramp extends between the frame and a surface wherein the ramp is configured for aiding the raising of the motorcycle to the track and such that the ramp is positionable in a raised configuration wherein the ramp extends perpendicularly from the frame for stowing the ramp and wherein the ramp is configured for retaining the load on the plate, the ramp comprising:
a gate panel, the gate panel being rectangularly shaped, the gate panel comprising diamond steel mesh,
a border beam coupled to a perimeter of the gate panel, and
a plurality of medial beams, each medial beam having opposing endpoints coupled to the border beam, the plurality of medial beams comprising seven medial beams substantially evenly spaced between opposing outer edges of the gate panel;
a panel strip coupled to an upward face of the ramp such that the panel strip is aligned with the track, the panel strip being textured wherein the panel strip is configured for increasing traction of the wheels of the motorcycle on the ramp;
a plurality of fenders coupled to and extending from the opposing sides of the frame such that each fender is positioned for shielding at least one trailer wheel, the plurality of fenders comprising two fenders coupled singly to the opposing sides of the frame; and
a pair of indicators, the pair of indicators being selectively operationally couplable to a control module of a vehicle coupled to the tongue, each indicator being coupled to a respective siderail adjacent to the back of the frame wherein the indicators are configured for selectively signaling braking and turning of the vehicle.
